(19) United States
(12) Patent Application Publication
(10) Pub. No.: US 2021/0197368 A1
(43) Pub. Date: Jul. 1, 2021

(54) ROBOT PLANNING FOR ENVELOPE INVARIANTS

(71) Applicant: X Development LLC, Mountain View, CA (US)

(72) Inventors: Andre Gaschler, Munich (DE); Tim Niemueller, Gauting (DE)

(21) Appl. No.: 16/731,531

(22) Filed: Dec. 31, 2019

(51) Int. Cl. B25J 9/16; B25J 13/08

(52) U.S. Cl. CPC B25J 9/163; B25J 9/1674; B25J 13/088; B25J 9/1661; B25J 9/1679

(57) ABSTRACT

This specification describes how a system can detect that an envelope invariant with a corresponding condition has been violated and, in response to the detection, perform an automatic recovery action.

### BACKGROUND

This specification relates to robotics, and more particularly to planning robotic movements.

Robotics planning refers to scheduling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone. In addition, a schedule that is manually generated for one workcell can generally not be used for other workcells. In this specification, a workcell is the physical environment in which one or more robots will operate. Workcells have particular physical properties, e.g., physical dimensions that impose constraints on how robots can move within the workcell. Thus, a manually programmed schedule for one workcell may be incompatible with a workcell having different robots, a different number of robots, or different physical dimensions.

Furthermore, if the schedule breaks down (e.g., because of a fault or an unexpected event), an operator has to manually reset the system and restart the schedule. This is a slow, manual process that is performed by the operator, which also causes the system to go offline. In addition, all the work that has been completed up until the breakdown is lost and in many instances has to be walked back.

### SUMMARY

This specification describes how a system can detect that an envelope invariant with a corresponding condition has been violated and, in response to the detection, perform an automatic recovery. Specifically, the system receives an initial plan for performing a particular task with a robot having a sensor. The initial plan can include a sequence of two or more actions. The sequence of the three two or more actions can include a first action followed by a second action. The system processes the initial plan to determine that the initial plan includes an envelope invariant. The envelope invariant can include a condition that holds between the first action of the sequence and the second action of the sequence. The system executes the initial plan including performing the first action in the sequence and determines that the envelope invariant has been violated before performing the second action in the sequence. In response to determining that the envelope invariant has been violated before performing the second action in the sequence, the system performs a recovery operation.

In some implementations, the system can receive an initial plan for performing a particular task, the initial plan including a sequence of three or more actions. The sequence can include a first action followed by a second action which is followed by a third action. For example, the plan can include a first action of picking up an object using a robot arm, a second action of moving the robot arm with the object within the grasp of the robot arm, and a third action of placing the object at a target location.

The system processes the initial plan to determine that the initial plan includes an envelope invariant. The envelope invariant can include a condition that holds between the first action of the sequence and the third action of the sequence (e.g., the condition remains satisfied during the time period between the first action of the sequence and the third action of the sequence). For example, in the above scenario, the condition can be that the object, after it has been picked up, has to be in the grasp of the robot arm until it is placed at the target location. When the system executes the initial plan including performing the first action in the sequence, the system can receive online observation data and based on that data determine whether the condition still holds.

The system can then determine that the envelope invariant has been violated prior to performance of the third action in the sequence (e.g., during the second action). As the system performs sensing operations to detect whether the condition still holds, the system can detect that the condition no longer holds. For example, when the object is no longer within the grasp of the robot arm (e.g., dropped), the system can determine that the envelope invariant has been violated. In response to determining that the envelope invariant has been violated before performing the third action in the sequence, the system performs a recovery operation. For example, the system can detect where the object is located (e.g., where it was dropped) and generate a recovery plan for picking up the object and moving the object to the target location. When the recovery operation(s) are completed, the system can execute the third action in the sequence.

Particular embodiments of the subject matter described in this specification can be implemented so as to realize one or more of the following advantages. The operator no longer has to manually reset the system and restart the initial plan, thus avoiding a slow manual process that has to be performed. In addition the system does not have to go offline for the problem to be fixed. Furthermore, no work has to be redone or restarted as a result of the failure. The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIG. 2 is a flowchart of an example process for detecting that an envelope invariant has been violated and performing a recovery operation.

FIG. 3 illustrates an example of a state machine for performing robot actions.

FIG. 4 illustrates performing planned actions and a recovery actions based on whether the envelope invariant has been violated.

Like reference numbers and designations in the various drawings indicate like elements.

### DETAILED DESCRIPTION

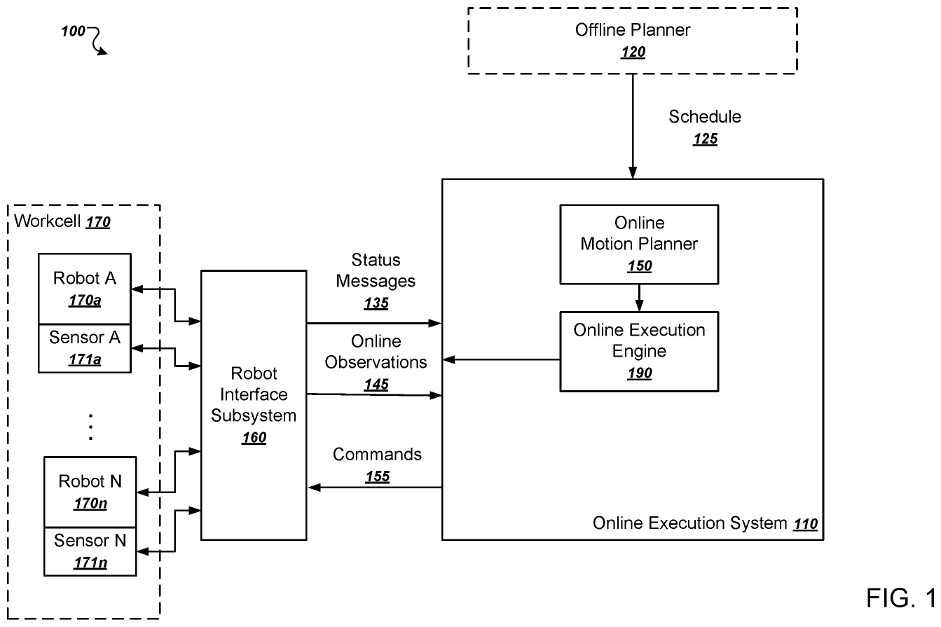

FIG. 1 is a diagram that illustrates an example system 100. The system 100 is an example of a system that can implement the online robotic control techniques described in this specification.

The system 100 includes a number of functional components, including an online execution system 110 and a robot interface subsystem 160. Each of these components can be implemented as computer programs installed on one or more computers in one or more locations that are coupled to each other through any appropriate communications network, e.g., an intranet or the Internet, or combination of networks.

In general, the online execution system 110 provides commands 155 to be executed by the robot interface subsystem 160, which drives one or more robots, e.g., robots 170a-n, in a workcell 170. The online execution system 110 also includes online execution engine 190 that communicates with the robot interface subsystem 160. In order to compute the commands 155, the online execution system 110 (e.g., using the online execution engine 190) consumes status messages 135 generated by the robots 170a-n and online observations 145 made by one or more sensors 171a-n making observations within the workcell 170. As illustrated in FIG. 1, each sensor 171 is coupled to a respective robot 170. However, the sensors need not have a one-to-one correspondence with robots and need not be coupled to the robots. In fact, each robot can have multiple sensors, and the sensors can be mounted on stationary or movable surfaces in the workcell 170.

The robot interface subsystem 160 and the online execution system 110 can operate according to different timing constraints. In some implementations, the robot interface subsystem 160 is a real-time software control system with hard real-time requirements. Real-time software control systems are software systems that are required to execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation.

The online execution system 110, on the other hand, typically has more flexibility in operation. In other words, the online execution system 110 may, but need not, provide a command 155 within every real-time time window under which the robot interface subsystem 160 operates. However, in order to provide the ability to make sensor-based reactions, the online execution system 110 may still operate under strict timing requirements. In a typical system, the real-time requirements of the robot interface subsystem 160 require that the robots provide a command every 5 milliseconds, while the online requirements of the online execution system 110 specify that the online execution system 110 should provide a command 155 to the robot interface subsystem 160 every 20 milliseconds. However, even if such a command is not received within the online time window, the robot interface subsystem 160 need not necessarily enter a fault state.

Thus, in this specification, the term online refers to both the time and rigidity parameters for operation. The time windows are larger than those for the real-time robot interface subsystem 160, and there is typically more flexibility when the timing constraints are not met.

The system 100 can also optionally include an offline planner 120. The overall goal of the offline planner 120 is to generate, from a definition of one or more tasks to be performed, a schedule that will be executed by the robots 170a-n to accomplish the tasks. In this specification, a schedule is data that assigns each task to at least one robot. A schedule also specifies, for each robot, a sequence of actions to be performed by the robot. A schedule also includes dependency information, which specifies which actions must not commence until another action is finished. A schedule can specify start times for actions, end times for actions, or both.

The offline planning process is typically computationally expensive. Thus, in some implementations, the offline planner 120 is implemented by a cloud-based computing system comprising many, possibly thousands, of computers. The offline planner 120 is thus commonly physically remote from a facility that houses the workcell 170. On the other hand, the online execute engine 110 is typically local to the facility that houses the workcell 170.

This arrangement thus provides three different computing zones. The offline planner 120 can use massive cloud-based computing resources to consider many possibilities for scheduling tasks, while also allowing for online reaction to unanticipated events by the online execution engine 190, while also providing the precision and real-time safety mechanisms of the robot interface subsystem 160.

Thus, in operation, the online execution system 110 obtains a workcell-specific schedule 125 and issues commands 155 to the robot interface system 160 in order to actually drive the movements of the moveable components, e.g., the joints, of the robots 170a-n. In some implementations, the robot interface subsystem 160 provides a hardware-agnostic interface so that the commands 155 issued by onsite execution engine 190 are compatible with multiple different versions of robots. During execution the robot interface subsystem 160 can report status messages 135 back to the online execution system 110 so that the online execution system 190 can make online adjustments to the robot movements, e.g., due to local faults or other unanticipated conditions.

In execution, the robots 170a-n generally continually execute the commands specified explicitly or implicitly by the motion plans to perform the various tasks or transitions of the schedule. The robots can be real-time robots, which means that the robots are programmed to continually execute their commands according to a highly constrained timeline. For example, each robot can expect a command from the robot interface subsystem 160 at a particular frequency, e.g., 100 Hz or 1 kHz. If the robot does not receive a command that is expected, the robot can enter a fault mode and stop operating.

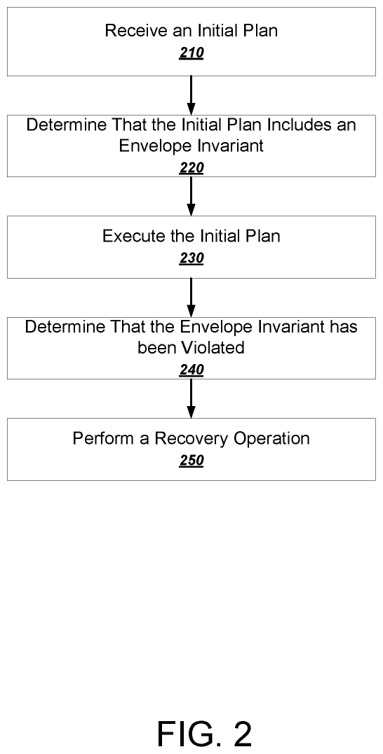

The online execution engine 190 can make online adjustments to the robot movements, e.g., due to local faults or other unanticipated conditions. FIG. 2 is a flowchart of an example process for detecting that an envelope condition has been violated and performing a recovery operation. At 210, the online execution system receives an initial plan for performing a particular task. The initial plan can include a sequence of three or more actions, a first action followed by a second action which is followed by a third action. In some implementations, the online execution system can receive an initial plan that has two or more actions with the second action following the first action. The online execution engine 190 can receive the initial plan from the online motion planner 150 which can generate the initial plan using a schedule 125 received from the offline planner 120. Invariants, preconditions and effects can be inferred/determined automatically depending on a type of action. The offline planner or the online execution engine can infer/determine from the types of actions what conditions (invariant, precondition, effect) must hold and what recovery strategy can be used, and, from variable assignments in the initial plan, infer/determine which concrete sensor measurement needs to be taken to measure that condition. The offline planner or the online execution engine can also assign arguments to the invariant violation check and recovery operations, relative to the type of action, the variables in the initial plan, and the current state of the workcell. For example, an assembly action may require as a precondition that a certain workpiece has an orientation within a small range. If this is violated, the online execution engine plans a recovery operation, passing the current workpiece position and orientation, and performs a pick-and-place action that brings the workpiece to a state from which the assembly action can start.

At 220, the online execution system determines that the initial plan includes an envelope invariant. For example, the online execution engine 190 can process the initial plan to determine that the initial plan includes an envelope invariant. The envelope invariant can include a condition that holds between a first action of the sequence and a second action in the sequence. The first action and the second action need not be adjacent actions in the sequence. In other words, the sequence can also include other intervening actions in the sequence, and the system can determine that the plan includes an envelope invariant by virtue of the condition holding through some or all intervening actions in the sequence.

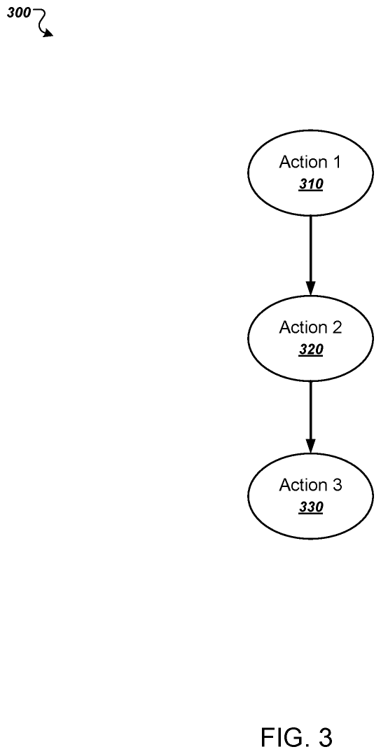

FIG. 3 illustrates an example of three actions that can be scheduled for a robot to perform. Each of the three actions can correspond to an envelope invariant which in turn can have a corresponding condition. For example, action 310 can be an action instructing the robot to pick up an item (e.g., using the robot arm). Action 310 is followed by action 320 that can instruct a robot to move the object to a specific location. Action 320 is followed by action 330 that can instruct the robot to put the object down. Each of these actions can have an envelope invariant with a condition that is tracked by the online execution engine 190. To track whether condition has been violated, the online execution engine 190 can receive online observations and/or status messages through the robot interface subsystem 160. The online observations and/or the status messages can include sensor data from sensors 171a-n (e.g., for each robot). To continue with the example above, the sensor 171a can correspond to robot 170a and can detect changes related to the robot 170a. For example, if the envelope invariant includes condition for actions 310, 320, and 330 that specifies that the object has to be within the grasp of the robot prior to executing action 330, the online execution engine can receive online observations 145 and/or status messages 135 from robot 170a and sensor 171a that indicate whether the object is still within the grasp of the robot. Although, FIG. 3 is shown with three actions, as described above the system can also detect envelope invariants between two actions in a sequence.

At 230, the online execution system begins execution of the initial plan by executing the first action. For example, the online execution engine 190 can send a command to one of the robots 170 to execute an action. The targeted robot can execute an action (e.g., action 310) and transmit back to the online execution engine 190 one or more status messages 135 and/or one or more online observations 145.

At 240, the online execution system determines that the envelope invariant has been violated. The determination can be made before the third action in the sequence is performed. In some implementations, the system determines that the envelope invariant has been violated before the second action in the sequence of two or more actions. For example, the online execution engine 190 can analyze one or more status messages 135 and/or one or more online observations 145 to determine whether the envelope invariant has been violated. For example, each sensor 171 can be a camera that can detect whether an object is within the grasp of a robot 170. In some implementations, a sensor 171 can be a pressure sensor that can detect whether an object is within a grasp of the robot. In some implementations, the sensor can be a sensor package with a combination of a camera, pressure sensor, location sensor, and/or other suitable sensor(s).

The sensor can send back to the online execution engine one or more observations indicating whether the envelope invariant has been violated. Specifically, an online observation can be image data (e.g., from a camera), pressure value (e.g., from a pressure sensor), location (e.g., from a location sensor), or other suitable data. The online execution engine 190 can analyze the received data to determine whether the condition corresponding to the envelope invariant has been violated. For example, each possible condition can include one or more types of sensors that can be used to determine whether the condition is violated. For each type of sensor for the given condition, the online execution engine can store a value indicating when the condition has been violated and when the condition has not been violated. For example, if a condition is whether an object is within the grasp of the robot, the system can have a specific pressure value (or range of values) that indicate that the object is within the grasp. In another example, if a condition is that a specific tool (e.g., a welding tool) is attached to the robot, an image can be used by the online execution engine to determine whether that specific tool is attached to the robot.

In another example, the envelope invariant can include a condition that a robot has to be in a specific position. Thus, the online execution engine 190 determines that the envelope invariant has been violated by determining that the robot is not in an expected position. The online execution engine can use sensor data (e.g., image data from a camera, location data from a location sensor and/or another suitable data) to determine the position of the robot. The online execution engine can compare the position of the robot with an expected position (e.g., identified based on the initial plan). If the position of the robot does not match the expected position, the online execution engine 190 determines that the envelope invariant has been violated.

In some implementations, one or more actions in a sequence can include one or more preconditions. For example, a third action in the sequence can be placing an object at a particular location. A precondition of this action is that the robot is in a specific location so that the object can be placed in that location. Therefore, the online execution system when determining that the envelope invariant has been violated before performing the third action in the sequence, can determine that a precondition of the third action in the sequence has been violated. That is, if one or more preconditions of the third action in the sequence have been violated, the online execution engine determines that the envelope invariant has been violated. In some implementations, the online execution engine can determine one or more preconditions based on the received initial plan. Each precondition can be stored in a data structure that the online execution engine can access. Prior to executing each action in the sequence, the online execution engine can retrieve one or more preconditions (e.g., from a data structure) corresponding to the particular action in the sequence. The online execution engine 190 can compare each precondition with online observations 145 received from the sensors 171 via the robot interface subsystem 160. For example, a precondition can be a set of coordinates where the robot have to be positioned and the online observations can be a current position of the robot. If the positions do not match, the precondition is violated.

In some implementations, the envelope invariant is violated when a particular effect is not achieved. For example, an effect of the first action, second action, and third action can be to place an object at a particular location. If the object is not placed at that location, then the effect is not achieved. The online execution system can determine (e.g. via a sensor 171) whether an effect has been achieved. If the online execution system determines, by analyzing sensor data, that the effect has not been achieved, the online execution system determines that the envelope invariant has been violated.

In some implementations, the online execution system performs the following actions to determine whether the envelope invariant has been violated. The online execution system repeatedly checks, within a robotic control loop, a memory location representing a precondition relating to the envelope invariant. For example, the sensor data for a particular precondition can be placed in a specific memory location within the robotic control loop. The online execution system can repeatedly check that location, retrieve a value from that memory location and compare the value to known values representing a failure and/or success determinations for a specific precondition. The online execution system can determine that the value at the memory location has changed and based on the change, determine that a precondition has been violated. For example, the value can be a pressure value that indicates that an object is within the grasp of the robot. If that value changes to a different value (e.g., by more than a trivial number), the online execution system can determine that the envelope invariant has been violated.

Referring back to FIG. 2, at 250, in response to determining that the envelope invariant has been violated before performing the third action in the sequence, the online execution system performs a recovery operation. For example, the online execution engine 190 can detect (e.g., based on online observations received from sensor) that an object is no longer within the grasp of the robot. In response, the online execution engine can use a sensor to locate the object, instruct the robot to maneuver to the object, pick up the object and, maneuver the robot to the proper location (e.g., location programmed into the sequence). In some implementations, the online execution system performs a recovery operation in response to determining that the envelope invariant has been violated before performing the second action in the sequence of two or more actions.

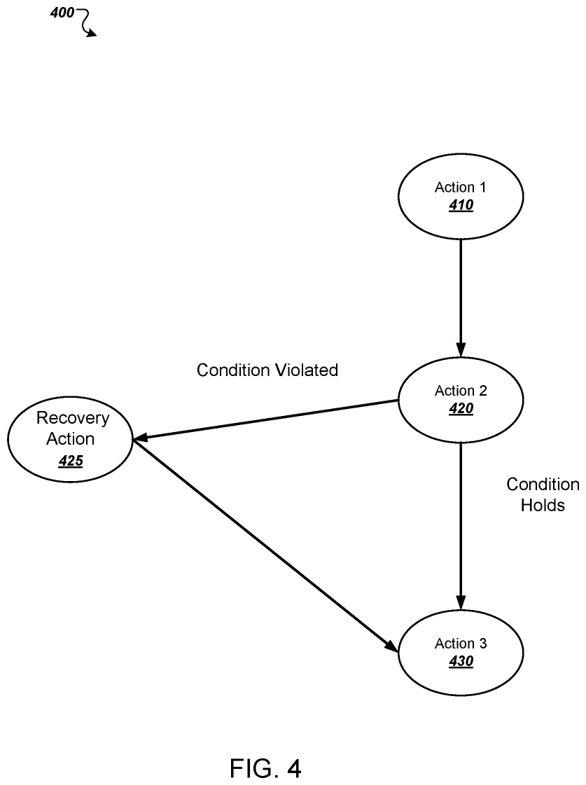

FIG. 4 illustrates performing planned actions and a recovery actions based on whether the envelope invariant has been violated. Action 410 of FIG. 4 illustrates the first action in the sequence of actions. For example, action 410 can be a weld operation being performed on an object. Action 420 can be a move action to move an object that the robot is holding to another location. As discussed above, the envelope invariant can include a condition that the robot has to have the object in the grasp. After (or during) action 420, the online execution system can determine that the condition has been violated and instead of proceeding to action 430, the online execution system can proceed to a recovery action 425. However, the online execution system has to generate the recovery action 425 prior to executing the recovery action 425. Based on determining that the condition has been violated, the online execution system can retrieve the initial execution plan and determine during which operation/action the condition has been violated. The online execution system can determine which actions of the initial plan still need to be completed and also determine the state of the system. For example, the state of the system can include locating an object that was dropped and the actions of the initial plan that need to be executed can include placing the object at a particular location and performing a weld operation. When the state of the system and actions to be performed are determined, the online execution system can generate one or more recovery actions to bring the system back into executing the initial plan. For example, the recovery actions can include moving the robot to a location where the object was dropped, picking up the object, and moving the robot to the position indicated in the initial plan. From there, the initial plan can continue executing. For example, the workcell can perform a weld operation as indicated in the initial plan. The recovery action 425 can include one or more actions that enable the online execution system to place the robot into a position to perform action 430.

In some implementations, the online execution system determines all preconditions that are needed to achieve a particular effect needed before the next action can be performed. For example, if the next action to be performed is a welding action, the preconditions of the actions can include moving an object to be welded into a particular position at a particular orientation. When the online execution system determines all preconditions that are needed, the online execution system generates a recovery plan to achieve all preconditions for achieving the particular effect. For example, the online execution system can generate a plan that includes one or more actions to achieve the effect.

In some implementations, the recovery operation can be based on the sequence of actions. For example, if the sequence of actions includes a first action that directs the robot to pick up an object, a second sequence that directs a robot to move the object, and the third action direction the robot to place the object, the recovery operation, in response to dropping the object, can include performing a retraction operation that, for example, enables a sensor of the robot to detect the new location of the object. When the new location of the object is determined, the online execution system can direct the robot to pick up the object, move the object to a proper location and retry one or more of the actions in the sequence (e.g., place the object at a location specified by the initial sequence).

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

In this specification, a task is an operation to be performed by a tool. For brevity, when a robot has only one tool, a task can be described as an operation to be performed by the robot as a whole. Example tasks include welding, glue dispensing, part positioning, and surfacing sanding, to name just a few examples. Tasks are generally associated with a type that indicates the tool required to perform the task, as well as a position within a workcell at which the task will be performed.

In this specification, a motion plan is a data structure that provides information for executing an action, which can be a task, a cluster of tasks, or a transition. Motion plans can be fully constrained, meaning that all values for all controllable degrees of freedom for the robot are represented explicitly or implicitly; or underconstrained, meaning that some values for controllable degrees of freedom are unspecified. In some implementations, in order to actually perform an action corresponding to a motion plan, the motion plan must be fully constrained to include all necessary values for all controllable degrees of freedom for the robot. Thus, at some points in the planning processes described in this specification, some motion plans may be underconstrained, but by the time the motion plan is actually executed on a robot, the motion plan can be fully constrained. In some implementations, motion plans represent edges in a task graph between two configuration states for a single robot. Thus, generally there is one task graph per robot.

In this specification, a motion swept volume is a region of the space that is occupied by a least a portion of a robot or tool during the entire execution of a motion plan. The motion swept volume can be generated by collision geometry associated with the robot-tool system.

In this specification, a transition is a motion plan that describes a movement to be performed between a start point and an end point. The start point and end point can be represented by poses, locations in a coordinate system, or tasks to be performed. Transitions can be underconstrained by lacking one or more values of one or more respective controllable degrees of freedom (DOF) for a robot. Some transitions represent free motions. In this specification, a free motion is a transition in which none of the degrees of freedom are constrained. For example, a robot motion that simply moves from pose A to pose B without any restriction on how to move between these two poses is a free motion. During the planning process, the DOF variables for a free motion are eventually assigned values, and path planners can use any appropriate values for the motion that do not conflict with the physical constraints of the workcell.

The robot functionalities described in this specification can be implemented by a hardware-agnostic software stack, or, for brevity just a software stack, that is at least partially hardware-agnostic. In other words, the software stack can accept as input commands generated by the planning processes described above without requiring the commands to relate specifically to a particular model of robot or to a particular robotic component. For example, the software stack can be implemented at least partially by the onsite execution system 110 and the robot interface subsystem 160 of FIG. 1.

The software stack can include multiple levels of increasing hardware specificity in one direction and increasing software abstraction in the other direction. At the lowest level of the software stack are robot components that include devices that carry out low-level actions and sensors that report low-level statuses. For example, robots can include a variety of low-level components including motors, encoders, cameras, drivers, grippers, application-specific sensors, linear or rotary position sensors, and other peripheral devices. As one example, a motor can receive a command indicating an amount of torque that should be applied. In response to receiving the command, the motor can report a current position of a joint of the robot, e.g., using an encoder, to a higher level of the software stack.

Each next highest level in the software stack can implement an interface that supports multiple different underlying implementations. In general, each interface between levels provides status messages from the lower level to the upper level and provides commands from the upper level to the lower level.

Typically, the commands and status messages are generated cyclically during each control cycle, e.g., one status message and one command per control cycle. Lower levels of the software stack generally have tighter real-time requirements than higher levels of the software stack. At the lowest levels of the software stack, for example, the control cycle can have actual real-time requirements. In this specification, real-time means that a command received at one level of the software stack must be executed and optionally, that a status message be provided back to an upper level of the software stack, within a particular control cycle time. If this real-time requirement is not met, the robot can be configured to enter a fault state, e.g., by freezing all operation.

At a next-highest level, the software stack can include software abstractions of particular components, which will be referred to motor feedback controllers. A motor feedback controller can be a software abstraction of any appropriate lower-level components and not just a literal motor. A motor feedback controller thus receives state through an interface into a lower-level hardware component and sends commands back down through the interface to the lower-level hardware component based on upper-level commands received from higher levels in the stack. A motor feedback controller can have any appropriate control rules that determine how the upper-level commands should be interpreted and transformed into lower-level commands. For example, a motor feedback controller can use anything from simple logical rules to more advanced machine learning techniques to transform upper-level commands into lower-level commands. Similarly, a motor feedback controller can use any appropriate fault rules to determine when a fault state has been reached. For example, if the motor feedback controller receives an upper-level command but does not receive a lower-level status within a particular portion of the control cycle, the motor feedback controller can cause the robot to enter a fault state that ceases all operations.

At a next-highest level, the software stack can include actuator feedback controllers. An actuator feedback controller can include control logic for controlling multiple robot components through their respective motor feedback controllers. For example, some robot components, e.g., a joint arm, can actually be controlled by multiple motors. Thus, the actuator feedback controller can provide a software abstraction of the joint arm by using its control logic to send commands to the motor feedback controllers of the multiple motors.

At a next-highest level, the software stack can include joint feedback controllers. A joint feedback controller can represent a joint that maps to a logical degree of freedom in a robot. Thus, for example, while a wrist of a robot might be controlled by a complicated network of actuators, a joint feedback controller can abstract away that complexity and exposes that degree of freedom as a single joint. Thus, each joint feedback controller can control an arbitrarily complex network of actuator feedback controllers. As an example, a six degree-of-freedom robot can be controlled by six different joint feedback controllers that each control a separate network of actual feedback controllers.

Each level of the software stack can also perform enforcement of level-specific constraints. For example, if a particular torque value received by an actuator feedback controller is outside of an acceptable range, the actuator feedback controller can either modify it to be within range or enter a fault state.

To drive the input to the joint feedback controllers, the software stack can use a command vector that includes command parameters for each component in the lower levels, e.g. a positive, torque, and velocity, for each motor in the system. To expose status from the joint feedback controllers, the software stack can use a status vector that includes status information for each component in the lower levels, e.g., a position, velocity, and torque for each motor in the system. In some implementations, the command vectors also include some limit information regarding constraints to be enforced by the controllers in the lower levels.

At a next-highest level, the software stack can include joint collection controllers. A joint collection controller can handle issuing of command and status vectors that are exposed as a set of part abstractions. Each part can include a kinematic model, e.g., for performing inverse kinematic calculations, limit information, as well as a joint status vector and a joint command vector. For example, a single joint collection controller can be used to apply different sets of policies to different subsystems in the lower levels. The joint collection controller can effectively decouple the relationship between how the motors are physically represented and how control policies are associated with those parts. Thus, for example if a robot arm has a movable base, a joint collection controller can be used to enforce a set of limit policies on how the arm moves and to enforce a different set of limit policies on how the movable base can move.

At a next-highest level, the software stack can include joint selection controllers. A joint selection controller can be responsible for dynamically selecting between commands being issued from different sources. In other words, a joint selection controller can receive multiple commands during a control cycle and select one of the multiple commands to be executed during the control cycle. The ability to dynamically select from multiple commands during a real-time control cycle allows greatly increased flexibility in control over conventional robot control systems.

At a next-highest level, the software stack can include joint position controllers. A joint position controller can receive goal parameters and dynamically compute commands required to achieve the goal parameters. For example, a joint position controller can receive a position goal and can compute a set point for achieve the goal.

At a next-highest level, the software stack can include Cartesian position controllers and Cartesian selection controllers. A Cartesian position controller can receive as input goals in Cartesian space and use inverse kinematics solvers to compute an output in joint position space. The Cartesian selection controller can then enforce limit policies on the results computed by the Cartesian position controllers before passing the computed results in joint position space to a joint position controller in the next lowest level of the stack. For example, a Cartesian position controller can be given three separate goal states in Cartesian coordinates x, y, and z. For some degrees, the goal state could be a position, while for other degrees, the goal state could be a desired velocity.

These functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
receiving an initial plan for performing a particular task with a robot having a sensor, wherein the initial plan includes a sequence of two or more actions, and wherein the sequence of the two or more actions comprises a first action followed by a second action;
processing the initial plan to determine that the initial plan includes an envelope invariant, wherein the envelope invariant comprises a condition that holds between the first action of the sequence and the second action of the sequence;
executing the initial plan including performing the first action in the sequence;
determining that the envelope invariant has been violated before performing the second action in the sequence; and
in response to determining that the envelope invariant has been violated before performing the second action in the sequence, performing a recovery operation.

2. The method of claim 1, wherein the initial plan comprises a third action which follows the second action, and wherein the condition holds between the second action of the sequence and the third second action of the sequence.

3. The method of claim 2, wherein determining that the envelope invariant has been violated before performing the third action in the sequence comprises determining that the robot is not in an expected position.

4. The method of claim 2, wherein determining that the envelope invariant has been violated before performing the third action in the sequence comprises determining that a precondition of the third action in the sequence has been violated.

5. The method of claim 1, wherein determining that the envelope invariant has been violated before performing the third action in the sequence comprises determining that a particular effect was not achieved.

6. The method of claim 5, wherein performing a recovery operation comprises: determining all preconditions for achieving the particular effect; and
generating a recovery plan to achieve all preconditions for achieving the particular effect.

7. The method of claim 1, wherein determining that the envelope invariant has been violated comprises:
repeatedly checking, within a robotic control loop, a memory location representing a precondition relating to the envelope invariant; and
determining that a value at the memory location has changed.

8. The method of claim 2, wherein the first action of the sequence comprises picking up an object from a first location, the second action of the sequence comprises moving the object, and the third action of the sequence comprises placing the object at a second location.

9. The method of claim 8, wherein performing the recovery operation comprises:
performing a retraction motion;
determining, using the sensor a third location of the object; and
retrying one or more of the actions in the sequence.

10. A system comprising: one or more computers and one or more storage devices storing instructions that are operable, when executed by the one or more computers, to cause the one or more computers to perform the actions of:
receiving an initial plan for performing a particular task with a robot having a sensor, wherein the initial plan includes a sequence of two or more actions, and wherein the sequence of the two or more actions comprises a first action followed by a second action;
processing the initial plan to determine that the initial plan includes an envelope invariant, wherein the envelope invariant comprises a condition that holds between the first action of the sequence and the second action of the sequence;
executing the initial plan including performing the first action in the sequence;
determining that the envelope invariant has been violated before performing the second action in the sequence; and
in response to determining that the envelope invariant has been violated before performing the second action in the sequence, performing a recovery operation.

11. The system of claim 10, wherein the initial plan comprises a third action which follows the second action, and wherein the condition holds between the second action of the sequence and the third second action of the sequence.

12. The system of claim 11, wherein determining that the envelope invariant has been violated before performing the third action in the sequence comprises determining that the robot is not in an expected position.

13. The system of claim 11, wherein determining that the envelope invariant has been violated before performing the third action in the sequence comprises determining that a precondition of the third action in the sequence has been violated.

14. The system of claim 10, wherein determining that the envelope invariant has been violated before performing the third action in the sequence comprises determining that a particular effect was not achieved.

15. The system of claim 14, wherein performing a recovery operation comprises:
determining all preconditions for achieving the particular effect; and
generating a recovery plan to achieve all preconditions for achieving the particular effect.

16. The system of claim 10, wherein determining that the envelope invariant has been violated comprises:
repeatedly checking, within a robotic control loop, a memory location representing a precondition relating to the envelope invariant; and
determining that a value at the memory location has changed.

17. The system of claim 11, wherein the first action of the sequence comprises picking up an object from a first location, the second action of the sequence comprises moving the object, and the third action of the sequence comprises placing the object at a second location.

18. The system of claim 17, wherein performing the recovery operation comprises:
performing a retraction motion;
determining, using the sensor a third location of the object; and
retrying one or more of the actions in the sequence.

19. A computer storage medium encoded with a computer program, the program comprising instructions that are operable, when executed by data processing apparatus, to cause the data processing apparatus to perform the actions of:
receiving an initial plan for performing a particular task with a robot having a sensor, wherein the initial plan includes a sequence of two or more actions, and wherein the sequence of the two or more actions comprises a first action followed by a second action;
processing the initial plan to determine that the initial plan includes an envelope invariant, wherein the envelope invariant comprises a condition that holds between the first action of the sequence and the second action of the sequence;
executing the initial plan including performing the first action in the sequence;
determining that the envelope invariant has been violated before performing the second action in the sequence; and
in response to determining that the envelope invariant has been violated before performing the second action in the sequence, performing a recovery operation.

20. The computer storage medium of claim 19, wherein the initial plan comprises a third action which follows the second action, and wherein the condition holds between the second action of the sequence and the third second action of the sequence.

21. The computer storage medium of claim 20, wherein determining that the envelope invariant has been violated before performing the third action in the sequence comprises determining that the robot is not in an expected position.

22. The computer storage medium of claim 20, wherein determining that the envelope invariant has been violated before performing the third action in the sequence comprises determining that a precondition of the third action in the sequence has been violated.

23. The computer storage medium of claim 19, wherein determining that the envelope invariant has been violated before performing the third action in the sequence comprises determining that a particular effect was not achieved.

24. The computer storage medium of claim 23, wherein performing a recovery operation comprises: determining all preconditions for achieving the particular effect; and
generating a recovery plan to achieve all preconditions for achieving the particular effect.

25. The computer storage medium of claim 19, wherein determining that the envelope invariant has been violated comprises:
repeatedly checking, within a robotic control loop, a memory location representing a precondition relating to the envelope invariant; and
determining that a value at the memory location has changed.

26. The computer storage medium of claim 20, wherein the first action of the sequence comprises picking up an object from a first location, the second action of the sequence comprises moving the object, and the third action of the sequence comprises placing the object at a second location.

27. The computer storage medium of claim 26, wherein performing the recovery operation comprises:
performing a retraction motion;
determining, using the sensor a third location of the object; and
retrying one or more of the actions in the sequence.
